(19) United States
(12) Patent Application Publication
(10) Pub. No.: US 2006/0044347 A1
(43) Pub. Date: Mar. 2, 2006

(54) Inkjet printer head and method of fabricating the same

(76) Inventors: Myong-jong Kwon, Suwon-si (KR); Kyong-il Kim, Seoul (KR); Kwang-ryul Kim, Suwon-si (KR); Nam-kyun Kim, Seongnam-si (KR); Byung-ha Park, Suwon-si (KR); Yong-shik Park, Seongnam-si (KR); Eun-bong Han, Suwon-si (KR); Young-ung Ha, Suwon-si (KR); Sung-joon Park, Suwon-si (KR); Jae-sik Min, Suwon-si (KR)

Correspondence Address: STANZIONE & KIM, LLP, 919 18TH STREET, N.W., SUITE 440, WASHINGTON, DC, 20006, US

(21) Appl. No.: 11/071,363

(22) Filed: Mar. 4, 2005

(30) Foreign Application Priority Data
Aug. 26, 2004 (KR) 2004-67635

(51) Int. Cl. B41J 2/135

(52) U.S. Cl. 347/44

(57) ABSTRACT

An inkjet printer head includes a substrate having an ink-feed hole to supply ink stored in a cartridge to an ink chamber and a restrictor in fluid communication with the ink chamber, an oxide layer formed on the substrate, a heater disposed on the oxide layer above the restrictor and having fixed parts disposed on the oxide layer, slopes extending upward and away from the restrictor at an incline, and a parallel part extending between the slopes parallel to the substrate, a lead formed to be in electrical contact with the heater, a chamber layer formed to cover the lead and to define the ink chamber, and a nozzle layer formed on the chamber layer and having a nozzle. In the inkjet printer head, the lifespan of the heater may be extended since the heater is supported by the slopes, which function as a shock absorbing member when ink supply pressure or cavitation force is applied to a surface of the heater. In addition, since the heater does not have a right angle structure, the heater may be formed to have a uniform thickness even when a thin layer used for the heater is formed by a deposition method.

### CROSS-REFERENCE TO RELATED APPLICATIONS

This application claims the benefit of Korean Patent Application No. 2004-67635, filed Aug. 26, 2004, the disclosure of which is hereby incorporated herein by reference in its entirety.

### BACKGROUND OF THE INVENTION

1. Field of the Invention

The present general inventive concept relates to an inkjet printer head and a method of fabricating the same, and more particularly, to an inkjet printer head used to eject ink from an inkjet printer and a method of manufacturing the same.

2. Description of the Related Art

An inkjet printer is a type of image forming apparatus that prints a desired image by ejecting droplets of ink stored in an ink cartridge to a surface of a recording medium. The ink stored in the ink cartridge is ejected by an inkjet printer head. The inkjet printer head may generally be classified into two categories including a thermal driving type that ejects the ink droplets using pressure of bubbles generated in the ink by a heater and a piezoelectric driving type that ejects the ink droplets using pressure applied to the ink due to mechanical deformation of a piezoelectric material caused by energizing the piezoelectric material.

FIG. 1 illustrates a conventional thermal driving type inkjet printer head. The inkjet printer head has an ink-feed hole 12 formed in a substrate 10 to supply ink from the ink cartridge to the inkjet printer head and a chamber layer 14 formed on the substrate 10 having an ink chamber 18 to temporarily store the ink. The substrate 10 has a restrictor 16 to supply the ink from the ink feed hole 12 into the ink chamber 18. A nozzle 20 is formed above the chamber layer 14, and a heater 22 is formed under the nozzle 20. In order to prevent the heater 22 from being damaged due to a reaction of the heater 22 to the ink, a passivation layer 24 is formed on a top surface of the heater 22. In addition, the heater 22 is connected to a pad 26, and the pad 26 is connected to a main body of the inkjet printer through a flexible printed circuit board (PCB) (not shown).

When a pulse current is applied to the heater 22, the heater 22 is instantly heated to generate bubbles on the top surface of the heater 22, and ink droplets 28 are discharged through the nozzle 20 by pressure created by the bubbles. However, as illustrated in FIG. 1, heat is only transferred from the top surface of the heater 22, therefore heat generated from a bottom surface of the heater 22 only increases a temperature of the chamber layer 14 of the inkjet printer head, but does not further heat the ink. Moreover, the passivation layer 24 located on the top surface of the heater 22 reduces efficiency of heat transferred from the top surface of the heater 22.

In an attempt to solve the aforementioned problems, U.S. Pat. No. 6,669,333 discloses an inkjet printer head illustrated in FIG. 2, including a chamber layer 54 formed on a substrate 50 for defining an ink chamber 57. The substrate 50 has an ink-feed hole 52, a restrictor 56, and a heater 58 for heating the ink introduced through the restrictor 56 located at a center of the ink chamber 57. The heater 58 heats the ink at both surfaces of the heater 58. Since the ink used with the inkjet printer head of FIG. 2 has a relatively low conductivity, it is not necessary to form a passivation layer on the heater 58. Omitting the passivation layer allows the heater 58 to maintain heat transfer efficiency. Additionally, since heating is performed by both surfaces of the heater 58, ink droplets may be ejected using an electric power lower than an electric power used by conventional inkjet printer heads.

In the conventional inkjet printer heads, when an electric current is not applied to a heater after ejecting ink droplets, bubbles formed in an ink chamber are reduced to apply a cavitation force on the surface of the heater. As a result, the heater becomes deformed and is damaged. However, in the heater 58 illustrated in FIG. 2, since generation or extinction of the bubbles is performed in directions opposite to each other at both surfaces of the heater 58, the cavitation force applied to the heater 58 is reduced, thereby extending a lifespan of the heater 58.

However, since the heater 58 is shaped as a right-angle structure rather than as a planar structure, a bent portion of the heater 58 may have a thickness that is formed irregularly. That is, the heater 58 is generally made by depositing a heater material using a sputtering or chemical vapor deposition (CVD) method, and then patterning the heater material. Therefore, as described, it is difficult to form the heater 58 to have a desired thickness at the bent portion of a right angle. Since the thickness of the heater material is formed irregularly around the bent portion, there is a high probability of an electrical short circuit due to concentration of current density when the bent portion has a thin thickness. Therefore, the heater 58 experiences disadvantages in productivity as well as a difficulty in precisely adjusting a calorific value of the heater 58 during operation.

The nozzle layer 59 is formed on the chamber layer 54 after forming a sacrificial layer using a photoresist, and the sacrificial layer is removed during manufacturing. Since the chamber layer 54 may be etched while removing the sacrificial layer, the selection of a material for forming the chamber layer 54 is limited. For example, it may be impossible to use a polymer-based material for the chamber layer 54 and the nozzle layer 59. In addition, since the nozzle layer 59 is irregular all over the inkjet printer head, wiping the nozzle layer 59 becomes almost impossible. Hydrophobic treatment also becomes difficult.

With respect to the conventional inkjet printer heads, although a thin layer used for a heater is typically formed on a sacrificial layer made of the photoresist, a process temperature required to form the thin layer is limited due to temperature sensitive characteristics of the photoresist used for the sacrificial layer. As a result, it is difficult to form a high quality thin layer for the heater, and selection of heater material is also limited. Further, since it is difficult to completely remove the sacrificial layer, there is a high probability that a remaining portion of the sacrificial layer may block an ink flow path or a nozzle during operation.

### SUMMARY OF THE INVENTION

The present general inventive concept provides an inkjet printer head capable of maintaining high efficiency characteristics, preventing damage due to cavitation force, and maintaining an original shape to enable long-term use.

The present general inventive concept also provides a method of fabricating an inkjet printer head capable of diversifying materials used to form a nozzle layer and a chamber layer and preventing a nozzle from being blocked due to a remaining portion of a sacrificial layer, since the nozzle layer may be formed without forming a sacrificial layer.

The present general inventive concept also provides a method of fabricating an inkjet printer head capable of forming a high quality thin layer for a heater by using a process temperature that is sufficiently high to effectively deposit the thin layer for the heater, since a temperature sensitive photoresist sacrificial layer is not used.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing an inkjet printer head including: a substrate having an ink-feed hole to supply ink stored in a cartridge to an ink chamber and a restrictor in fluid communication with the ink chamber; an oxide layer formed on the substrate; a heater disposed on the oxide layer above the restrictor and having fixed parts disposed on the oxide layer, slopes extending upward and away from the restrictor at an incline, and a parallel part extending between the slopes parallel to the substrate; a lead formed to be in electrical contact with the heater; a chamber layer formed to cover the lead and to define the ink chamber; and a nozzle layer formed on the chamber layer and having a nozzle.

The heater may be spaced apart from the substrate and with top and bottom surfaces disposed to be in contact with the ink. The heater may include the fixed parts supported on the substrate, and the parallel part disposed in parallel with the substrate and to cross the restrictor. The fixed parts and the parallel part are connected by the slopes inclined upward and toward the nozzle (i.e., away from the restrictor). That is, the parallel part and the slopes of the heater may form a trapezoid shape when viewing the inkjet printer head from a side angle.

The lead may transmit a pulse current to the heater. The heater and the lead may be formed by depositing a thin layer, patterning the thin layer to define a heater portion and a lead portion on the thin layer, and implanting impurities in the thin layer so that the heater portion has a high resistance in comparison with the lead portion. Accordingly, the heater and the lead may be integrally formed. Alternatively, the lead may be formed separately on the heater after the heater is formed by patterning the thin layer. When the lead is integrally formed with the heater, a portion of the fixed parts may be the lead. When the lead is separately formed on the heater, the lead may be disposed at both ends of the heater, i.e., on an upper portion of the fixed parts.

The heater may include at least two individually operated heaters disposed in the ink chamber. A dimension of ink droplets ejected through the nozzle may be adjusted by operating a particular number of the at least two individually operated heaters.

The nozzle layer may comprise a solid dry film. That is, since the nozzle layer is formed using the solid dry film rather than a liquid photoresist, it is not necessary to form a sacrificial layer to support the nozzle layer.

The foregoing and/or other aspects and advantages of the present general inventive concept are also achieved by providing a method of fabricating an inkjet printer head including forming a restrictor on a top surface of a substrate, forming an oxide layer on the top surface of the substrate on which the restrictor is formed, adhering a silicon wafer on the top surface of the substrate on which the oxide layer is formed and polishing the silicon wafer to a predetermined thickness, etching the silicon wafer to form a heater support, depositing a heater layer and a lead layer on the heater support and the oxide layer and patterning the heater layer and the lead layer to form a heater and a lead, forming a chamber layer on the heater and the lead, adhering a solid photoresist on the chamber layer and exposing the solid photoresist to form a nozzle layer having a nozzle, removing the heater support, forming an ink-feed hole on a rear surface of the substrate, and removing a lowermost portion of the oxide layer where the restrictor is formed.

The silicon wafer is used as a sacrificial layer to form the heater layer, because silicon, unlike photoresist typically used in conventional methods, maintains its characteristics at high process temperatures. As a result, a process temperature that is sufficiently high may be used during deposition of the heater layer and the lead layer. In addition, since the nozzle layer is formed by adhering the solid photoresist, it is not necessary to form a sacrificial layer to support the nozzle layer. As a result, it becomes possible to prevent the nozzle from being blocked due to remaining parts of a sacrificial layer that are typically used in conventional methods to support a nozzle layer formed of a liquid photoresist.

The substrate may be made of a silicon wafer.

The restrictor may be formed by a dry etching method after applying a photosensitive photoresist on the substrate and patterning the photosensitive photoresist using a photolithography method to form a restrictor pattern.

The oxide layer may be formed by a thermal oxidation method, a plasma enhanced chemical vapor deposition (PECVD) method, or a low pressure chemical vapor deposition (LPCVD) method.

Forming the heater and the lead may further include forming the heater by depositing a thin layer of a heater material on the oxide layer and the heater support and patterning the thin layer of the heater material, and forming the lead at both ends of the heater by depositing a metal thin layer on the heater and patterning the metal thin layer to form the lead. The heater may be formed of a material containing at least one of Ta, Pt, TaNx, TiNx, WNx, TaAl, Ta—Si—N, and W—Si—N. In addition, the method of fabricating an inkjet printer head may further include forming a passivation layer on the heater and the lead after the lead is formed.

Alternatively, the operation of forming the heater and the lead may include forming a conductive layer on the oxide layer and the heater support, patterning the conductive layer in a predetermined shape, and implanting impurities into a heater portion or a remaining portion other than the heater portion so that the heater portion has a relatively high resistance in comparison with a conductor. The heater and the lead may be formed by depositing and patterning a single thin layer. In this case, the method of fabricating an inkjet printer head may further include forming a passivation layer on the heater and lead.

The heater support may be formed by a wet etching method after forming an etching pattern on a top surface of the silicon wafer.

The chamber layer may be formed by applying a liquid photoresist on the silicon wafer by a spin coating method and exposing the liquid photoresist through a mask.

The heater support may be removed by a dry etching method. A XeF gas may be used.

The ink-feed hole may be formed by a dry silicon dip etching method after applying a photoresist on the rear surface of the substrate and patterning the photoresist to form an etching mask. The lowermost portion of the oxide layer where the restrictor is formed may be removed by a CHF₃ gas through the rear surface of the substrate.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view illustrating a conventional inkjet printer head;

FIG. 2 is a cross-sectional view illustrating another conventional inkjet printer head;

FIG. 3 is a cross-sectional view illustrating an inkjet printer head according to an embodiment of the present general inventive concept;

FIG. 4 is a perspective view in which a chamber layer and a nozzle layer are omitted for illustration purposes from the inkjet printer head of FIG. 3 according to an embodiment of the present general inventive concept;

FIG. 5 is a perspective view in which a chamber layer and a nozzle layer are omitted for illustration purposes from the inkjet printer head of FIG. 3 according to another embodiment of the present general inventive concept; and

FIGS. 6A to 6M are cross-sectional views illustrating a process of fabricating the inkjet printer head of FIG. 3 according to an embodiment of the present general inventive concept.

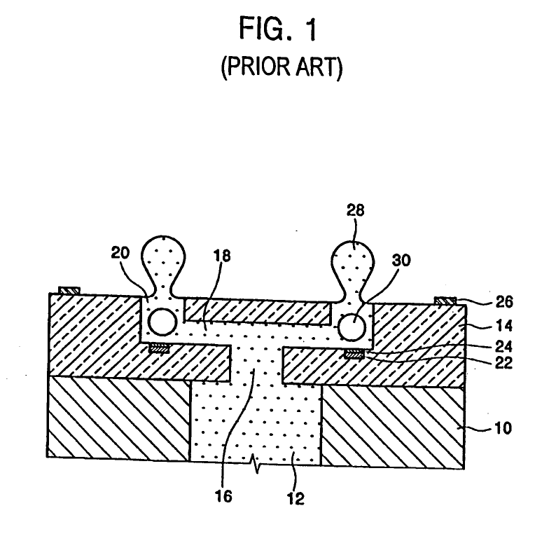

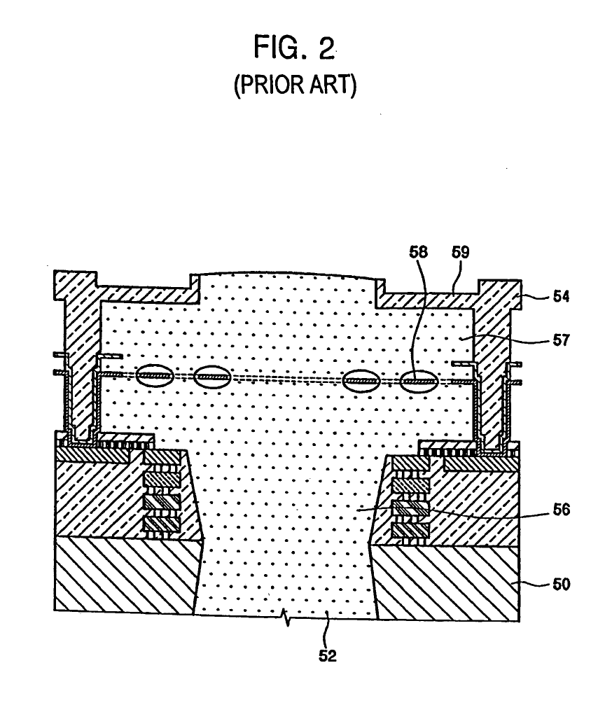

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Hereinafter, an inkjet printer head and method of fabricating the same in accordance with the present general inventive concept will be described in conjunction with the accompanying drawings.

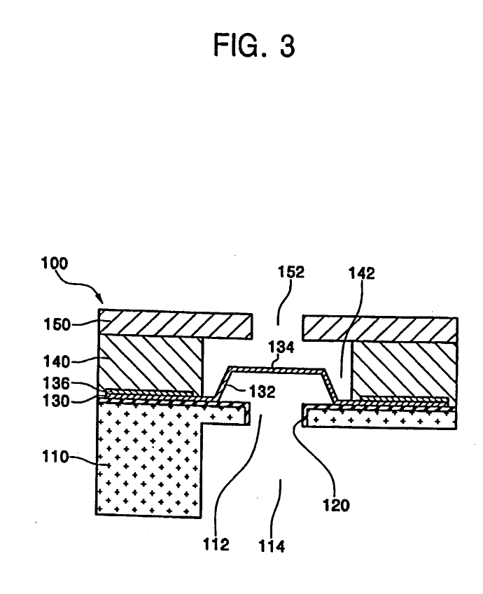

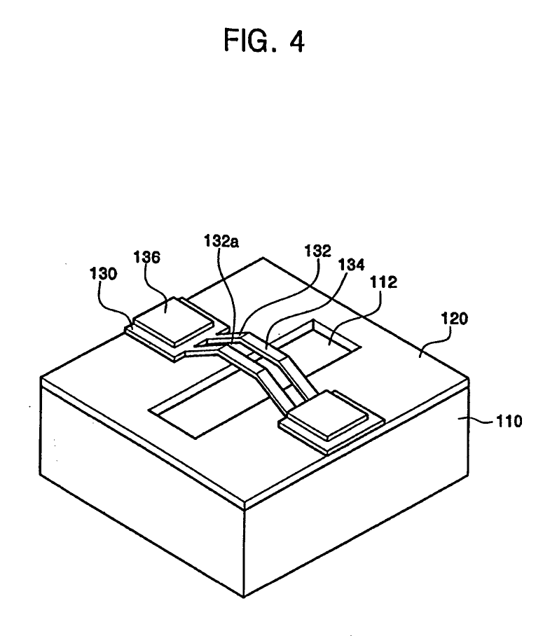

FIG. 3 is a cross-sectional view illustrating an inkjet printer head according to an embodiment of the present general inventive concept. FIG. 4 is a perspective view in which a chamber layer and a nozzle layer are omitted for illustration purposes from the inkjet printer head of FIG. 3 according to an embodiment of the present general inventive concept.

Referring to FIGS. 3 and 4, an inkjet printer head 100 has a substrate 110 at a lower portion. The substrate 110 may comprise a silicon wafer. The substrate 110 includes an ink-feed hole 114 formed on a bottom surface to be in fluid communication with an ink cartridge and to be supplied with ink from the ink cartridge. A restrictor 112 is formed on the ink-feed hole 114. The restrictor 112 may include a plurality of restrictors that are individually formed to correspond with a plurality of ink chambers in the inkjet printer head 100, and each of the plurality of restrictors may be formed to be in fluid communication with the ink-feed hole 114.

An oxide layer 120 may be formed on a top surface of the substrate 110. The oxide layer 120 is formed by oxidizing the top surface of the substrate 110. The oxide layer 120 is used in manufacturing a silicon on insulator (SOI) to prevent the substrate 110 from being damaged by a XeF gas used in a fabrication process thereof to remove a silicon sacrificial layer.

A heater attached on the oxide layer 120 includes a parallel part 134 (i.e., a top part), slopes 132 (i.e., side parts), and fixed parts 130. The heater is formed by patterning a heater material, as illustrated in FIG. 4, after forming a thin layer of the heater material on the oxide layer 120. The fixed parts 130 of the heater are located at a lower portion of a chamber layer 140 as described below, the slopes 132 extend upward at an incline from ends of the fixed parts 130, and the parallel part 134 is disposed between the slopes 132 such that the parallel part 134 is parallel to the substrate 110 and in a straight line. In other words, the fixed parts 130 are located on the oxide layer 120 parallel to the substrate 110, and the slopes 132 extend from the ends of the fixed parts 130 such that a distance therebetween becomes smaller as the slopes 132 extend away from the substrate 110 and toward the parallel part 134, as illustrated in FIG. 3.

The parallel part 134 is located between the slopes 132 and is disposed parallel to the top surface of the substrate 110. Because of the structure of the heater as described above, both surfaces of the slopes 132 and the parallel part 134 of the heater are in contact with the ink to increase thermal efficiency. In addition, even when the heater is deformed by pressure and cavitation force of the ink supplied by the restrictor 112, the slopes 132 perform a shock absorbing operation. This shock absorption operation extends a lifespan of the heater. Further, since the slopes 132 of the heater do not meet the parallel part 134 of the heater at a right angle, the heater may have a uniform thickness when the thin layer of the heater material is formed by a deposition process. The slopes 132 of the heater may have an angle of about 54.50 with respect to the top surface of the substrate 110. In addition, as illustrated in FIG. 4, the slopes 132 and the parallel part 134 of the heater may be divided into two parts by a slit 132a formed therebetween, because the structure as described above may reduce impact of ink supply pressure and cavitation force. A lead 136 is formed on the fixed parts 130 of the heater. The lead 136 connects a printer main body with the heater to supply electric current thereto. The lead 136 may be formed by the same process as the heater. The lead 136 may be patterned by a wet etching method. In addition, a passivation layer may be formed on a surface of the heater to protect the heater.

Alternatively, instead of forming the lead 136 and the heater separately, a lead and a heater may be formed from a single thin layer. Impurities may then be implanted therein to make a resistance of a heater region greater than a resistance of a lead region. In this case, the lead 136 would be omitted from FIG. 3, and the fixed part 130 of the heater may also function as the lead 136.

Referring back to FIG. 3, a chamber layer 140 is formed on the lead 136. The chamber layer 140 may be made of a material such as epoxy or imides. Since electrical problems may arise when the lead 136 comes in contact with the ink, the chamber layer 140 may be formed to fully cover the lead 136. An ink chamber 142 is formed in the chamber layer 140, a nozzle layer 150 is formed on the chamber layer 140, and a nozzle 152 to eject the ink from the ink chamber 142 is formed in the nozzle layer 150.

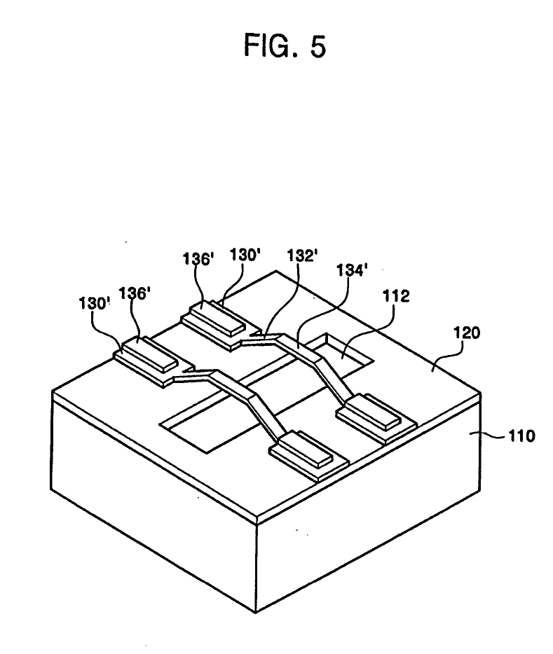

FIG. 5 is a perspective view in which the chamber layer 140 and the nozzle layer 150 are omitted for illustration purposes from the inkjet printer head of FIG. 3 according to another embodiment of the present general inventive concept. The inkjet printer head illustrated in FIG. 5 similar to the inkjet printer head 100 illustrated in FIG. 4 except that the inkjet printer head illustrated in FIG. 5 includes two separate heaters. Since each of the heaters is provided with a lead 136′ independently connected to the printer main body, the two heaters may be simultaneously operated. Alternatively, one of the two heaters may be operated to adjust a dimension of the ink droplets ejected from the nozzle 152. In addition, since each of the two heaters has a width smaller than that of the heater of the inkjet printer head illustrated in FIG. 4, the heaters may be impacted less by the ink supply pressure and cavitation force. Although the inkjet printer head of FIG. 5 illustrates two adjacent heaters, it should be understood that any number of heaters may be used with the present general inventive concept.

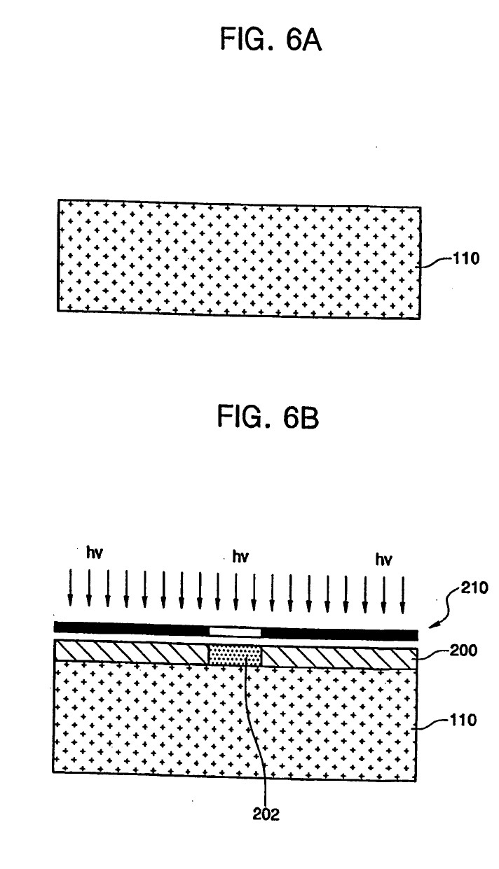

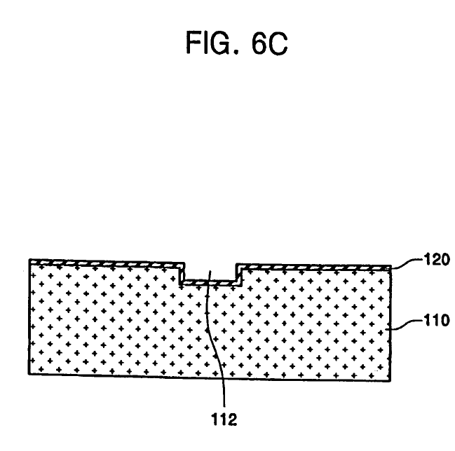

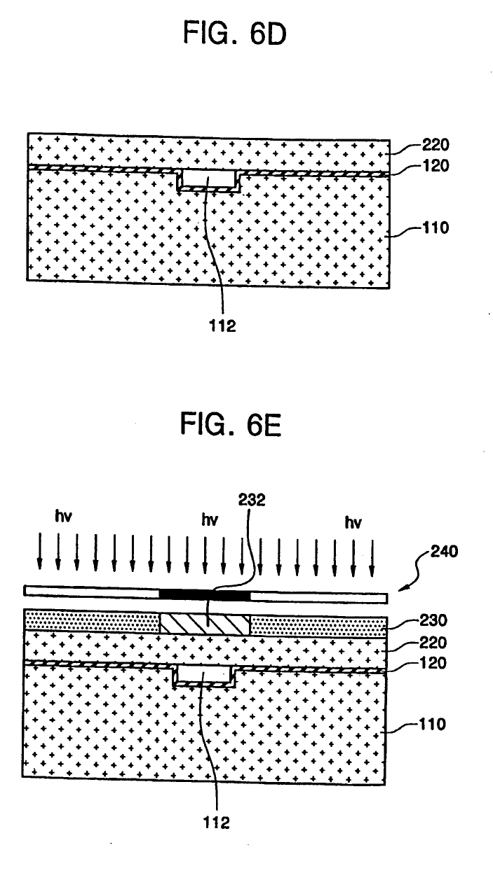

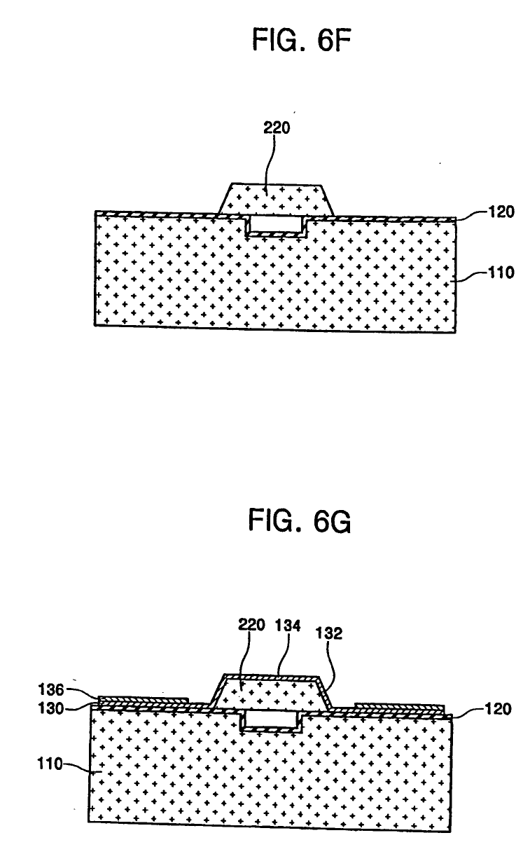

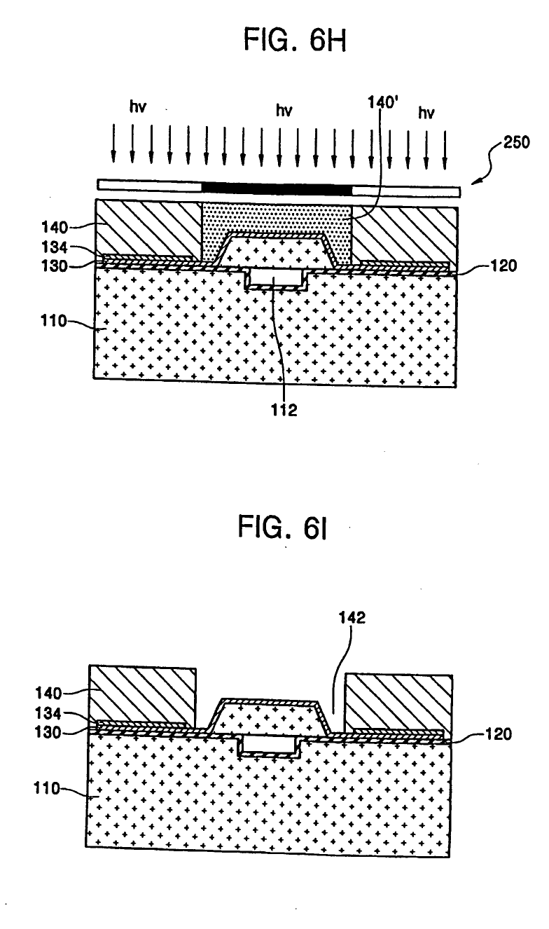

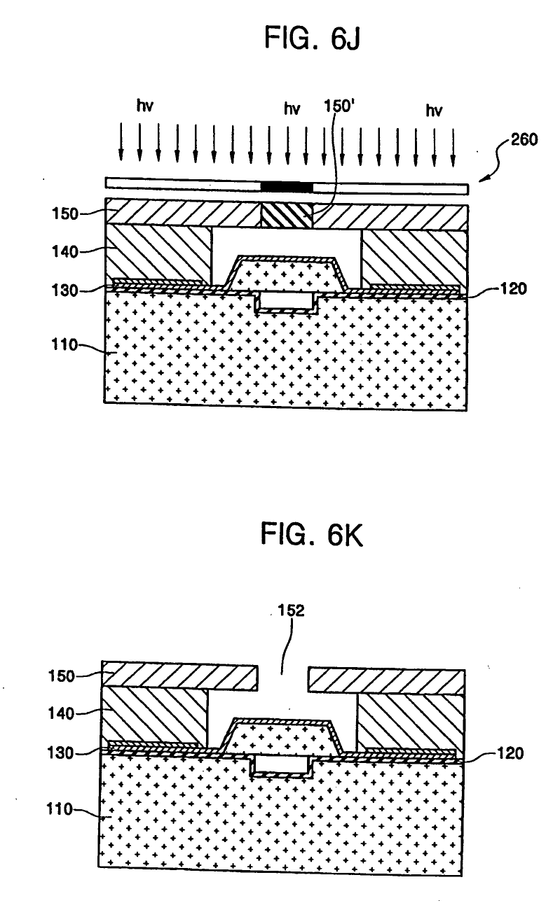

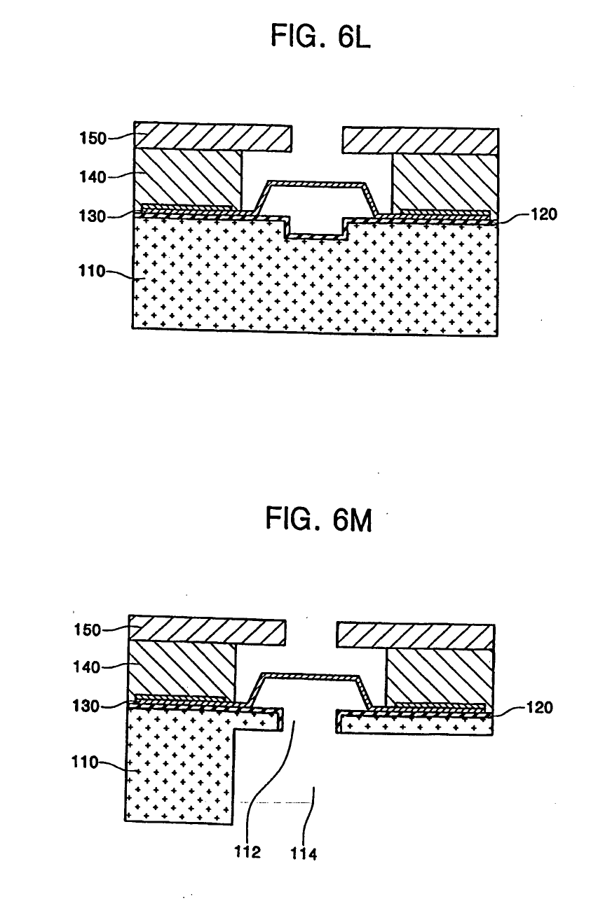

Hereinafter, a method of fabricating the inkjet printer head of FIG. 3 in accordance with an embodiment the present general inventive concept will be described with reference to FIGS. 6A to 6M.

As illustrated in FIG. 6A, a substrate 110 includes a silicon wafer is prepared. As illustrated in FIG. 6B, a first positive photosensitive photoresist layer 200 is applied on a top surface of the substrate 110. The first photoresist layer 200 is then exposed through a first mask 210 to remove a restrictor portion 202and to form a restrictor pattern to define where a restrictor 112 (FIG. 6C) is to be located. The restrictor 112 (FIG. 6C) may then be formed by a silicon anisotropic etching method, such as a Bosch process. The first photosensitive photoresist layer may be formed by a spin coating method.

As illustrated in FIG. 6C, an oxide layer 120 may then be formed on the top surface of the substrate 110 on which the restrictor 112 is formed. As described above, the oxide layer 120 is effectively used in the manufacture of a silicon on insulator (SOI) wafer in the following process, and prevents the substrate 110 from being damaged due to a XeF gas during a subsequent process of removing a silicon sacrificial layer. The oxide layer 120 may be formed by a thermal oxidation method, a plasma enhanced chemical vapor deposition (PECVD) method, or a low pressure chemical vapor deposition (LPCVD) method.

When the process of forming the oxide layer 120 is completed, a silicon wafer is adhered on the oxide layer 120 to form the SOI wafer and is to be used as a heater support 220 to be described below. The silicon wafer may then be polished to a desired thickness through a chemical mechanical polishing (CMP) process. The silicon wafer functions as a base on which a thin layer used for a heater and a lead is to be formed. The silicon wafer becomes a sacrificial layer, which is to be removed in a manufacturing process. Therefore, the silicon wafer has a thickness that corresponds to a distance in which the heater is spaced apart from the top surface of the substrate 110. When the silicon wafer is formed, a second positive photosensitive photoresist layer 230 (see FIG. 6E) is applied on a top surface of the silicon wafer, and a photolithography process of exposing the second photoresist layer 230 using a second mask 240 may then be performed to form an etching mask 232. As illustrated in FIG. 6E, the etching mask 232 defines locations at which slopes 132 (FIG. 6G) and a parallel part 134 (FIG. 6G) of the heater are to be formed. Thus, the etching mask 232 has the same width as the parallel part 134 (FIG. 6G) of the heater.

As illustrated in FIG. 6F, the heater support 220 may then be formed by a silicon wet etching method. The heater support 220 is a part-remaining after etching the silicon wafer. Both sides of the heater support 220 may have an angle of about 54.5° with respect to the substrate 110 and excellent surface illumination by the wet etching method. TMAH developer or potassium hydroxide (KOH) solution may be used as a wet etching solution.

After forming the heater support 220, a thin layer containing a material selected from a group including Tantalum (Ta), Platinum (Pt), Tantalum Nitride (TaNx), Titanium Nitride (TiNx), Tungsten Nitride (WNx), Tantalum Aluminum (TaAl), Tantalum Silicide (Ta—Si—N), and Tungsten Silicide (W—Si—N) is formed on the heater support 220, as illustrated in FIG. 6G. Since the thin layer is adhered by a deposition method, the heater support 220 has excellent surface illumination. Additionally, since both ends are inclined to have an angle of about 54.5° with respect to the top surface of the substrate 110 rather than a right angle, the thin layer may be formed to have a uniform thickness. Since the heater support 220 formed of the silicon wafer functions as the sacrificial layer rather than photoresist used in conventional methods, a process temperature that is sufficiently high may be used during the process of depositing the thin layer. As a result, the thin layer deposited on the heater support 220 to be formed as the heater is of a high quality.

After forming the thin layer, the thin layer is patterned by a photolithography method to form the fixed parts 130, the slopes 132, and the parallel part 134 of the heater. A lead 136 may then be formed on a top surface of the fixed parts 130 of the heater through the same process. The heater may have a relatively high resistance value by forming a single thin layer and implanting impurities therein.

Once the heater and the lead 136 are formed, a third photoresist layer made of a material such as epoxy or imides is applied on the heater and the lead 136 to be exposed through a third mask 250 to form a chamber layer 140 as illustrated in FIG. 6H. The third photoresist layer may be a liquid photoresist applied on an entire surface of the wafer by a spin coating method. As illustrated in FIG. 61, a chamber portion 140′ of the third photoresist layer is then patterned and removed to define an ink chamber 142.

As illustrated in FIG. 6J, a dry film such as a solid photoresist may then be laminated on the chamber layer 140 to form a nozzle layer 150. The dry film does not require forming a separate sacrificial layer since it is not liquid and need not be supported. A nozzle 152 may be readily formed in the nozzle layer 150 by the photolithography method. That is, the solid photoresist is exposed using a patterned mask 260 to remove a nozzle portion 150′ at which the nozzle 152 is to be formed. As illustrated in FIG. 6K, formation of the nozzle layer 150 is then complete. In addition, it is not necessary to remove a photoresist since a sacrificial layer of photoresist is not used. As a result, no problem arises even when an ink flow path layer is formed of a polymer. In addition, there are no potential problems caused by photoresist not fully removed blocking the ink flow path or the nozzle.

The heater support 220 located under the heater is removed through the nozzle 152, as illustrated in FIG. 6L. The heater support 220 is removed by a dry etching method in which a XeF gas may be used. The oxide layer 120 protects the substrate 110 from damage during this process.

Next, an etching mask having an ink-feed hole pattern is formed on a rear surface of the substrate 110. After forming the etching mask an ink-feed hole 114 is formed by a dry silicon dip etching method as illustrated in FIG. 6M. The etching process is stopped at a lowermost portion of the oxide layer 120 where the restrictor 112 is formed. The lowermost portion of the oxide layer 120 where the restrictor is formed may be removed by a CHF₃ gas.

As can be seen from the foregoing, the present general inventive concept is capable of extending the lifespan of a heater in an inkjet printer head, since the heater is supported by slopes that function as a shock absorbing member when ink supply pressure or cavitation force is applied to a surface of the heater. In addition, since the heater does not have a right angle structure, the heater may be formed to have a uniform thickness even when a thin layer used for the heater is formed by a deposition method.

Further, since the heater is formed on a heater support made of a silicon wafer, a process temperature that is sufficiently high may be used while the thin layer for the heater is formed. Additionally, since a nozzle layer is formed of a solid dry film and a process for removing a photoresist using an ashing process may be omitted, a chamber layer may be formed of a polymer, and it is possible to prevent a nozzle from being blocked by remaining photoresist.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet printer head, comprising:
a substrate having an ink-feed hole to supply ink stored in a cartridge to an ink chamber and a restrictor in fluid communication with the ink chamber;
an oxide layer formed on the substrate;
a heater disposed on the substrate to extend above the restrictor;
a lead formed to be in electrical contact with the heater;
a chamber layer formed to cover the lead and to define the ink chamber; and
a nozzle layer formed on the chamber layer and having a nozzle therein.

2. The inkjet printer head according to claim 1, wherein the heater comprises fixed parts disposed on the oxide layer, slopes extending upward and away from the restrictor at an incline, and a parallel part extending between the slopes parallel to the substrate.

3. The inkjet printer head according to claim 1, wherein the heater is integrally formed with the lead and has a resistance higher than that of the lead by implanting impurities therein.

4. The inkjet printer head according to claim 2, wherein the lead is disposed at top surfaces of the fixed parts of the heater.

5. The inkjet printer head according to claim 1, wherein the heater includes at least two individually operated heaters disposed in the ink chamber.

6. The inkjet printer head according to claim 1, wherein the nozzle layer comprises a dry film.

7. An inkjet printer head, comprising:
a substrate having an ink-feed hole extending therethrough to supply ink from an ink container;
an ink flow structure disposed on the substrate and having at least one ink chamber and at least one nozzle to eject ink therefrom; and
at least one heater disposed on the substrate in the at least one ink chamber to extend across the ink-feed hole and having a trapezoidal shape.

8. The inkjet printer head according to claim 7, wherein the at least one heater comprises two first parts each disposed flat on the substrate and on opposite sides of the ink-feed hole with respect to each other, two second parts each extending away from a respective first part and toward the at least one nozzle at an incline, and a third part to connect the two second parts.

9. The inkjet printer head according to claim 8, wherein the second parts are sloped with respect to the substrate and the third part is substantially parallel to the substrate.

10. The inkjet printer head according to claim 7, wherein the at least one heater comprises a plurality of heaters formed adjacent to one another in the at least one ink chamber and the plurality of heaters are individually operated to control a dimension of ink droplets ejected from the at least one nozzle.

11. The inkjet printer head according to claim 7, wherein the at least one heater comprises a plurality of heaters adjacent to one another and each of the plurality of heaters comprises two shared first parts each disposed flat on the substrate and on opposite sides of the ink-feed hole with respect to each other, two non-shared second parts extending away from a respective shared first part and toward the at least one nozzle at an incline, and a non-shared third part to connect the two non-shared second parts.

12. A method of fabricating an inkjet printer head, the method comprising:
forming a restrictor on a top surface of a substrate;
forming an oxide layer on the top surface of the substrate on which the restrictor is formed;
adhering a silicon wafer on the top surface of the substrate on which the oxide layer is formed and polishing the silicon wafer to a predetermined thickness;
etching the silicon wafer to form a heater support;
depositing a heater layer and a lead layer on the heater support and the oxide layer and patterning the heater layer and the lead layer to form a heater and a lead;
forming a chamber layer on the heater and the lead;
adhering a solid photoresist on the chamber layer and exposing the solid photoresist to form a nozzle layer having a nozzle therein;
removing the heater support;
forming an ink-feed hole on a rear surface of the substrate; and
removing a lowermost portion of the oxide layer where the restrictor is formed.

13. The method according to claim 12, wherein the substrate comprises a silicon wafer.

14. The method according to claim 12, wherein the restrictor is formed by a dry etching method, after applying a photosensitive photoresist on the substrate and patterning the photosensitive photoresist using a photolithography method to form a restrictor pattern.

15. The method according to claim 12, wherein the oxide layer is formed by one of a thermal oxidation method, a plasma enhanced chemical vapor deposition (PECVD) method, and a low pressure chemical vapor deposition (LPCVD) method.

16. The method according to claim 12, wherein forming the heater and the lead comprises:
forming the heater by depositing a thin layer made of a heater material on the oxide layer and the heater support and patterning the thin layer, and
forming the lead at both ends of the heater by depositing a metal thin layer on the heater and patterning the metal thin layer.

17. The method according to claim 16, wherein the heater is formed of a material containing at least one of Ta, Pt, TaNx, TiNx, WNx, TaAl, Ta—Si—N, and W—Si—N.

18. The method according to claim 17, further comprising:
after forming the lead, forming a passivation layer on the heater and the lead.

19. The method according to claim 12, wherein forming the heater and the lead comprises:
forming a conductive layer on the oxide layer and the heater support,
patterning the conductive layer in a predetermined shape, and
implanting impurities into a portion of the conductive layer so that the heater has a relatively high resistance in comparison with the lead.

20. The method according to claim 19, further comprising:
after forming the heater and the lead, forming a passivation layer thereon.

21. The method according to claim 12, wherein the heater support is formed by a wet etching method, after forming an etching pattern on a top surface of the silicon wafer.

22. The method according to claim 12, wherein the chamber layer is formed by applying a liquid photoresist on the silicon wafer by a spin coating method.

23. The method according to claim 12, wherein the heater support is removed by a dry etching method.

24. The method according to claim 12, wherein the ink-feed hole is formed by a dry silicon dip etching method, after applying a photoresist on the rear surface of the substrate and patterning the photoresist to form an etching mask.

25. The method according to claim 12, wherein the lowermost portion of the oxide layer where the restrictor is formed is removed by a CHF₃ gas through the rear surface of the substrate.

26. A method of fabricating an inkjet printer head, the method comprising:
forming an oxide layer on a substrate;
forming a silicon sacrificial layer to support at least one heater on the oxide layer by creating a silicon layer on the oxide layer and patterning the silicon layer;
depositing a heater layer on the oxide layer and the silicon sacrificial layer to form the at least one heater;
forming an ink-flow structure on the oxide layer and the heater having at least one ink chamber to store ink supplied by an ink-feed hole and at least one nozzle to eject ink heated by the at least one heater; and
removing the silicon sacrificial layer.

27. The method according to claim 26, further comprising:
forming an ink-feed hole to extend through the substrate and to supply ink to the at least one ink chamber so that the ink is heated by both surfaces of the at least one heater.

28. The method according to claim 26, wherein the silicon sacrificial layer is formed on the oxide layer to have two side surfaces extending upward and a top surface connected to the two side surfaces at non-right angles.

29. The method according to claim 26, wherein the silicon sacrificial layer meets the oxide layer on the substrate at an angle of about 54.5 degrees.

30. The method according to claim 26, wherein the silicon sacrificial layer is formed by adhering a silicon on insulator layer to the oxide layer, creating an etch mask using photoresist, and etching the silicon on insulator layer.

31. The method according to claim 26, wherein the depositing of the heater layer on the oxide layer and the silicon sacrificial layer to form the at least one heater comprises
depositing a thin resistance layer on the oxide layer and the silicon sacrificial layer to form the at least one heater, and
depositing a conductive layer on ends of the at least one heater to form leads to supply current to the at least one heater.

32. The method according to claim 26, wherein the depositing of the heater layer on the oxide layer and the silicon sacrificial layer to form the at least one heater comprises
depositing a thin conductive layer including a heater region and a lead region on the oxide layer and the silicon sacrificial layer, and
implanting impurities in the heater region so that the heater region is resistant and the lead region is conductive.

33. The method according to claim 26, wherein the depositing of the heater layer on the oxide layer and the silicon sacrificial layer to form the at least one heater further comprises patterning the heater layer to form a plurality of heaters in the heater layer.

34. The method according to claim 26, wherein the forming of the ink-flow structure comprises
forming a chamber layer on the oxide layer and the at least one heater having the at least one ink chamber, and
forming a nozzle layer having the at least one nozzle by adhering a solid photoresist layer to the chamber layer.
